(19) United States
(12) Patent Application Publication
(10) Pub. No.: US 2021/0384645 A1
(43) Pub. Date: Dec. 9, 2021

(54) Antenna Device and Electronic Apparatus

(71) Applicant: GUANGDONG OPPO MOBILE TELECOMMUNICATIONS CORP., LTD., Dongguan (CN)

(72) Inventor: Yuhu Jia, Dongguan (CN)

(21) Appl. No.: 17/409,315

(22) Filed: Aug. 23, 2021

Related U.S. Application Data
(63) Continuation of application No. PCT/CN2020/079160, filed on Mar. 13, 2020.

(30) Foreign Application Priority Data
Mar. 18, 2019 (CN) 201920343166.1

(51) Int. Cl. H01Q 21/20; H01Q 1/42; H01Q 1/24

(52) U.S. Cl. CPC H01Q 21/20; H01Q 1/24; H01Q 1/42

(57) ABSTRACT

An electronic apparatus is provided. The electronic apparatus includes a rear cover, an antenna module spaced from a rear cover, a radiation array configured to radiate millimeter wave signals and at least one array structure arranged on a first area of the rear cover. A beam of the millimeter wave signals points out of the rear cover. Each of the at least one array structure includes periodically arranged array members. The first area at least includes an area projected by the antenna module on the rear cover. The millimeter wave signals are coupled with the at least one array structure and radiated out of the rear cover through the at least one array structure.

### CROSS-REFERENCE TO RELATED APPLICATION(S)

The present disclosure is a continuation-application of International (PCT) Patent Application No. PCT/CN2020/079160 filed Mar. 13, 2020, which claims foreign priority of Chinese Patent Application No. 201920343166.1, filed on Mar. 18, 2019, the entire contents of both of which are hereby incorporated by reference.

### TECHNICAL FIELD

The present disclosure relates to the field of antenna technologies, and in particular, to an antenna device and an electronic apparatus.

### BACKGROUND

Statement here provides only background information related to the present disclosure, rather than necessarily constituting an embodiment of existing technology.

With development of a wireless communication technology, 5G network technology is born. 5G network, as a fifth generation mobile communication network, has a theoretical peak transmission speed of tens of Gb per second. A theoretical peak transmission speed of 5G network is hundreds of times faster than that of 4G network. Therefore, a millimeter wave band with enough spectrum resources has become one of working frequency bands of a 5G communication system.

Generally, multiple antenna modules for radiation millimeter wave signals can be set in a shell of an electronic apparatus (such as a mobile phone) to achieve large angle signal coverage. An antenna module is set corresponding to a rear cover of the mobile phone, and has a certain gap with the rear cover of the mobile phone. Because of high dielectric constant of the rear cover of the mobile phone, when millimeter wave signals are radiated, a surface wave mode will be excited, resulting in seriously affecting radiation efficiency of an antenna, causing directional pattern distortion of an array, and reducing gain of the antenna module.

### SUMMARY

An antenna device and an electronic apparatus are provided according to various embodiments of the present disclosure.

An electronic apparatus comprising a rear cover, an antenna module and at least one array structure. The antenna module is spaced from the rear cover and comprises a radiation array configured to radiate millimeter wave signals. A beam of the millimeter wave signals points out of the rear cover. The at least one array structure is arranged on a first area of the rear cover. Each of the at least one array structure comprises periodically arranged array members. The first area at least comprises an area projected by the antenna module on the rear cover, the millimeter wave signals are coupled with the at least one array structure and radiate out of the rear cover through the at least one array structure.

In addition, an antenna device for an electronic apparatus is provided. The antenna device comprises a rear cover, a middle board arranged spaced from and facing the rear cover; a plurality of antenna modules arranged on the middle board and an array structure configured to be arranged on the rear cover. The plurality of antenna modules are spaced from the rear cover. Each of the plurality of antenna modules comprises a radiation array configured to radiate millimeter wave signals. A beam of the millimeter wave signals is radiated towards the rear cover. An area of a vertical projection of the plurality of antenna modules on the rear cover is smaller than that of a vertical projection of the array structure on the rear cover, and a resonant cavity is formed by coupling the plurality of antenna modules and the at least one array structure, and the millimeter wave signals radiate out of the rear cover through the at least one array structure.

In addition, an electronic apparatus is also provided. The electronic apparatus comprises a rear cover, a display assembly, a middle board, an antenna module and at least one array structure. The display assembly is connected to the rear cover and defines an accommodation space with the rear cover. The middle board is arranged in the accommodation space and spaced from the rear cover. The antenna module is arranged on the middle board, located between the middle board and the rear cover and spaced from the rear cover. The antenna module comprises a radiation array arranged towards the rear cover, and configured to radiate millimeter wave signals, and a beam of the millimeter wave signals points out of the rear cover. The at least one array structure arranged on a first area of the rear cover. Each of the at least one array structure comprises periodically arranged array members, the first area at least comprises an area projected by the antenna module on the rear cover, the at least one array structure is excited by the millimeter wave signals, and the millimeter wave signals are coupled with signals radiated by the at least one array structure, and are radiated out of the rear cover.

Details of one or more embodiments of the present disclosure are disclosed in following drawings and description. Other features, objects and advantages of the present disclosure will become apparent from the description, the drawings and claims.

### BRIEF DESCRIPTION OF DRAWINGS

In order to make the technical solution described in the embodiments of the present disclosure or prior art more clearly, the drawings used for the description of the embodiments will be briefly described. Apparently, the drawings described below are only for illustration, but not for limitation. One skilled in the art may obtain other drawings based on these drawings, without making any inventive work.

FIG. 1 is a perspective view of an electronic apparatus provided by some embodiments.

FIG. 2 is a cross-sectional view of an antenna device in an electronic apparatus provided by some embodiments.

FIGS. 3a-3d are structure views of array structures provided by some embodiments.

FIG. 4 is a cross-sectional view of an antenna device in an electronic apparatus provided by some embodiments.

FIG. 5 is a cross-sectional view of an antenna device in an electronic apparatus provided by some embodiments.

FIG. 6 is a cross-sectional view of an antenna device in an electronic apparatus provided by some embodiments.

FIG. 7 is a block diagram of partial structure of a mobile phone related to an electronic apparatus provided by some embodiments of the present disclosure.

### DETAILED DESCRIPTION

In order to make the purpose, technical scheme and advantages of the present disclosure clearer, the present disclosure will be described more fully below with reference to the relevant drawings and embodiments. It should be understood that the described embodiments are used only to explain the present disclosure and are not used to limit the present disclosure.

It is understood that the terms “first”, “second” and the like in the present disclosure are used to describe various components but these components are not limited by these terms. These terms are only used to distinguish a component from another component, rather than to be understood as indicating or implying relative importance or implicitly indicating the number of technical features indicated. Thus, features defined as “first” and “second” may indicate or implicitly indicate including at least one of the features. In the description of the present disclosure, “multiple” means at least two, such as two, three and so on, unless otherwise specified.

It should be noted that when a component is called “arranged in/on” another component, the component can be arranged directly in/on another component or there can be a component in middle. When a component is considered to be “connected” to another component, the component can be directly connected to another component or there may be a middle component therein at the same time.

In some embodiments, an electronic apparatus is provided. The electronic apparatus comprises a rear cover, an antenna module spaced from the rear cover and at least one array structure arranged on a first area of the rear cover. The antenna module comprises a radiation array configured to radiate millimeter wave signals, and a beam of the millimeter wave signals points out of the rear cover. Each of the at least one array structure comprises periodically arranged array members, the first area at least comprises an area projected by the antenna module on the rear cover, the millimeter wave signals are coupled with the at least one array structure and radiate out of the rear cover through the at least one array structure.

Alternatively, geometry of a projection of the periodically arranged array members in a plane parallel to the rear cover is rotationally symmetric or axisymmetric.

Alternatively, each array member in the at least one array structure has same geometry, and an area of an array member arranged at a center of the at least one array structure is largest, and areas of the array members emitted from a center to surrounding are gradually reduced.

Alternatively, center distances or edge distances between any two adjacent array members are equal.

Alternatively, each array member in the at least one array structure has same geometry, and areas of each row of the array members in the at least one array structure gradually decrease or increase in a same direction.

Alternatively, each array member in the at least one array structure has same geometry, and an area of each array member is equal.

Alternatively, a distance between the array members and the radiation array of the antenna module is between 0.4 mm˜2 mm.

Alternatively, geometry of each array member is one of a rectangle, an inverted “H” shape, a toroidal shape, a circle and an ellipse.

Alternatively, the antenna device comprises a dielectric layer arranged on the rear cover. The at least one array structure is embedded in the dielectric layer.

Alternatively, the rear cover has a first surface and a second surface arranged opposite to each other; the at least one array structure is arranged on the first surface and in the first area of the rear cover.

Alternatively, a distance between the at least one array structure and the radiation array of the antenna module is between 0.4 mm˜1 mm.

Alternatively, the rear cover has a first surface and a second surface arranged opposite to each other; and the at least one array structure is arranged on the second surface and in the first area of the rear cover.

Alternatively, a distance between the at least one array structure and the radiation array of the antenna module is between 0.6 mm˜2 mm.

Alternatively, the rear cover has a first surface and a second surface arranged opposite to each other, and the at least one array structure is arranged inside the rear cover, and between the first surface and the second surface.

Alternatively, a distance between the at least one array structure and the radiation array of the antenna module is between 0.5 mm˜1.5 mm.

Alternatively, the rear cover has a first surface and a second surface arranged opposite to each other; the at least one array structure comprises a first array structure and a second array structure, the first array structure is arranged on the first surface and in the first area, and the second array structure is arranged on the second surface and in the first area.

Alternatively, a resonant cavity is defined by coupling the antenna module and the array structure, and the resonant cavity is configured to converge a transmitted millimeter wave.

In some embodiments, an antenna device for an electronic apparatus is provided. The antenna device comprises a rear cover, a middle board arranged spaced from and facing the rear cover; a plurality of antenna modules arranged on the middle board and an array structure arranged on the rear cover. The plurality of antenna modules are spaced from the rear cover. Each of the plurality of antenna modules comprises a radiation array configured to radiate millimeter wave signals. A beam of the millimeter wave signals is radiated towards the rear cover. An area of a vertical projection of the plurality of antenna modules on the rear cover is smaller than that of a vertical projection of the array structure on the rear cover, and a resonant cavity is formed by coupling the plurality of antenna modules and the at least one array structure, and the millimeter wave signals radiate out of the rear cover through the at least one array structure.

Alternatively, the array structure is arranged on a first area of the rear cover and comprises periodically arranged array members, geometry of a projection of the periodically arranged array members in a plane parallel to the rear cover is rotationally symmetric or axisymmetric.

In some embodiments, an electronic apparatus is provided. The electronic apparatus comprises a rear cover, a display assembly, a middle board, an antenna module and at least one array structure. The display assembly is connected to the rear cover and defines an accommodation space with the rear cover. The middle board is arranged in the accommodation space and spaced from the rear cover. The antenna module is arranged on the middle board, located between the middle board and the rear cover and spaced from the rear cover. The antenna module comprises a radiation array arranged towards the rear cover, and configured to radiate millimeter wave signals, and a beam of the millimeter wave signals points out of the rear cover. The at least one array structure is arranged on a first area of the rear cover. Each of the at least one array structure comprises periodically arranged array members, the first area at least comprises an area projected by the antenna module on the rear cover, the at least one array structure is excited by the millimeter wave signals, and the millimeter wave signals are coupled with signals radiated by the at least one array structure, and are radiated out of the rear cover.

An antenna device for an electronic apparatus is provided by an embodiment of the present disclosure. In one embodiment, the electronic apparatus can be a mobile phone, a tablet computer, a notebook computer, a palm computer, a mobile internet device (MID), a wearable device (such as a smart watch, a smart bracelet, a pedometer, etc.) or other communication modules capable of setting array antenna devices.

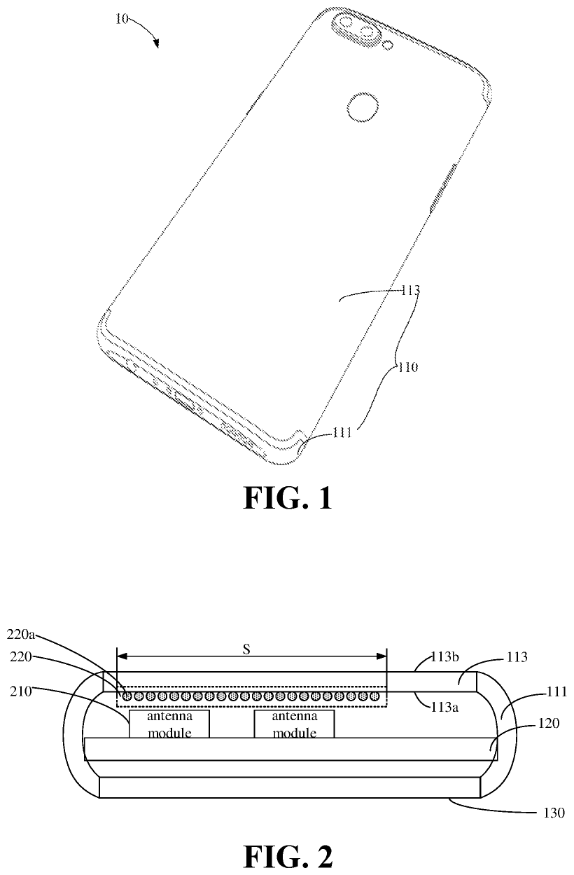

As shown in FIG. 1 and FIG. 2, in some embodiments of the present disclosure, the electronic apparatus 10 may include a housing assembly 110, a middle board 120, a display assembly 130 and a controller. The display assembly 130 is fixed on the housing assembly 110 and forms an external structure of the electronic apparatus together with the housing assembly 110. The housing assembly 110 may include a middle frame 111 and a rear cover 113. The middle frame 111 may be a frame structure having a through hole. The middle frame 111 can be accommodated in an accommodation space formed by the display assembly 130 and the rear cover 113. The rear cover 113 is configured to form an external contour of the electronic apparatus. The rear cover 113 can be integrally formed. In a forming process of the rear cover 113, a rear camera hole, a fingerprint identification module, an antenna device mounting hole and other structures can be formed on the rear cover 113. The rear cover 113 can be a non-metallic rear cover 113, for example, the rear cover 113 can be a plastic rear cover 113, a ceramic rear cover 113, a 3D glass rear cover 113, and so on. The middle board 120 is fixed inside the housing assembly 110, and the middle board 120 can be a printed circuit board (PCB) or a flexible printed circuit board (FPC). An antenna module configured to transmit and receive millimeter wave signals and a controller configured for controlling operations of the electronic apparatus can be integrated on the middle board 120. The display assembly 130 can be configured to display pictures or fonts, and can provide an operation interface for a user.

As shown in FIG. 1 and FIG. 2, in one embodiment, an antenna module 210 is integrated in the housing assembly 110. A beam of the antenna module 210 points out of the rear cover 113 and can transmit and receive the millimeter wave signals through the rear cover 113. Thus, the electronic apparatus 10 can achieve wide coverage of the millimeter wave signals.

A millimeter wave is an electromagnetic wave, wavelength of the electromagnetic wave is millimeter, and frequency of the electromagnetic wave is about in a range of 20 GHz-300 GHZ. 3GPP has specified a frequency band list supported by 5G NR, and a 5G NR spectrum range can reach 100 GHz and has specified two frequency ranges: frequency range 1 (FR1), i.e. a frequency band below 6 GHz and frequency range 2 (FR2), i.e. a millimeter wave band. A frequency range of the frequency 1 is 450 MHz-6.0 GHz, and a maximum channel bandwidth is 100 MHz. A frequency range of the frequency range 2 is 24.25 GHz-52.6 GHz, and the maximum channel bandwidth is 400 MHz. Near 11 GHz spectrum for 5G mobile broadband includes 3.85 GHz licensed spectrum, such as 28 GHz (24.25-29.5 GHz), 37 GHz (37.0-38.6 GHz), 39 GHz (38.6-40 GHz) and 14 GHz unlicensed spectrum (57-71 GHz). A working frequency band of the 5G communication system includes 28 GHz, 39 GHz and 60 GHz.

As shown in FIG. 2, an antenna device is provided by some embodiments of the present disclosure. The antenna device includes an antenna module 210 spaced from the rear cover 113 and at least one array structure 220 configured to be arranged on a first area S of the rear cover 113.

The antenna module 210 includes a radiation array configured to radiate the millimeter wave signals, and a beam of the millimeter wave signals points out of the rear cover 113. In one embodiment, the antenna module 210 may be arranged on the middle board 120 of the electronic apparatus. The middle board 120 can be a PCB (printed circuit board) or a FPC (flexible printed circuit board). The middle board 120 and the rear cover 113 are spaced from each other. A distance between the middle board 120 and the rear cover 113 can be set between 0.4 mm˜1 mm.

In one embodiment, a radiation array included in the antenna module 210 may be a phase controlled antenna array configured to radiate the millimeter wave signals. For example, the radiation array configured to radiate the millimeter wave signals may be an antenna array composed of a patch antenna, a dipole antenna, a Yagi antenna, a beam antenna or other suitable antenna components.

In one embodiment, the number of antenna modules 210 may be one or more. Multiple antenna modules 210 are integrated on the middle board 120 and integrated on a side of the middle board 120 facing the rear cover 113 in response to the number of antenna modules 210 being multiple. It should be noted that a radiation array arranged on each antenna module 210 can be the same or different in response to there being the multiple antenna modules 210. For example, the radiation array can be a patch antenna array, a dipole sky array, a Yagi antenna or the like.

In one embodiment, each of the at least one array structure 220 is configured to be arranged on the first area S of the rear cover 113. The first area S at least includes an area projected on the rear cover 113 by the antenna module 210. In other words, an area occupied by the at least one array structure 220 is the first area S of the rear cover 113, and an area of the first area S is greater than an area of the antenna module 210 projected in parallel on the rear cover 113.

It should be noted that the area of the first area S of the antenna modules 210 is greater than a sum of the areas projected in parallel on the rear cover 113 by all the antenna modules 210 in response to the number of the antenna modules 210 being multiple. That is, the area occupied by the at least one array structure 220 is greater than that occupied by all the antenna modules 210.

Each of the at least one array structure 220 includes periodically arranged array members 220a. The millimeter wave signals can radiate outside the rear cover 113 through of the at least one array structure 220, radiation area of the millimeter wave signals can be increased, and gain of the antenna module 210 can be increased. Meanwhile, the at least one array structure 220 includes the periodically arranged array members 220a. The at least one array structure 220 and the antenna module 210 constitute a resonant cavity. Directional pattern distortion of the antenna module 210 can be improved and radiation efficiency of the millimeter wave signals can be increased. Meanwhile, the resonant cavity converges a transmitted millimeter wave, sharpens a beam, suppresses sidelobe, avoids energy emitted by each antenna module 210 leaking to adjacent radiation area, and increases isolation between multiple antenna modules 210.

Furthermore, the at least one array structure 220 may be configured to radiate the millimeter wave signals, that is, in the embodiment of the present disclosure, antenna radiator may include the radiation array and the at least one array structure 220 on the antenna module 210. Compared with a traditional radiation array with only the antenna module 210 to radiate the millimeter wave signals, when the radiation area of the millimeter wave signals is required to be the same, size of the radiation array in the antenna module 210 may be reduced, and area of the antenna module 210 occupying the middle board 120 may be reduced to reduce space occupied by the antenna module 210.

In addition, the at least one array structure 220 can be configured to radiate millimeter wave signals. In some embodiments, millimeter wave signals radiated by the radiation array of the antenna module 210 can resonate with the at least one array structure 220 and then be radiated to far-field through the rear cover 113. Thus, standing wave of the millimeter wave signals can be improved, deterioration of standing wave caused by the millimeter wave signals transmitted by the rear cover 113 can be avoided, then impedance bandwidth of the antenna can be improved and millimeter wave wide band coverage can be realized.

In the above antenna device, the at least one array structure 220 is configured to be arranged on the rear cover 113, the area occupied by the at least one array structure 220 is larger than the area occupied by the antenna module 210, and the at least one array structure 220 can be configured to radiate the millimeter wave signals. Thus, the radiation area of the millimeter wave signals can be increased, the gain of antenna module 210 can be improved. Meanwhile, the at least one array structure 220 can also improve the impedance bandwidth of the antenna, thus, the at least one array structure 220 is also suitable for the millimeter wave wide band coverage, and improves the isolation between multiple antenna modules 210.

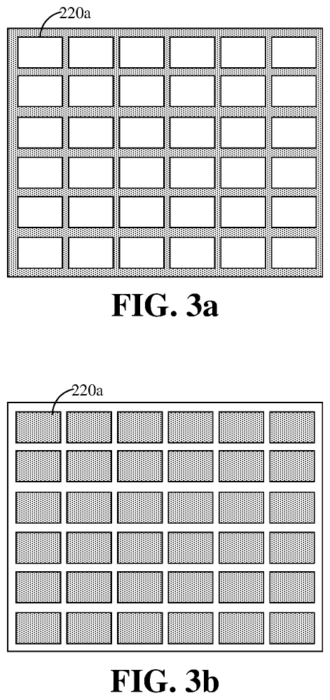

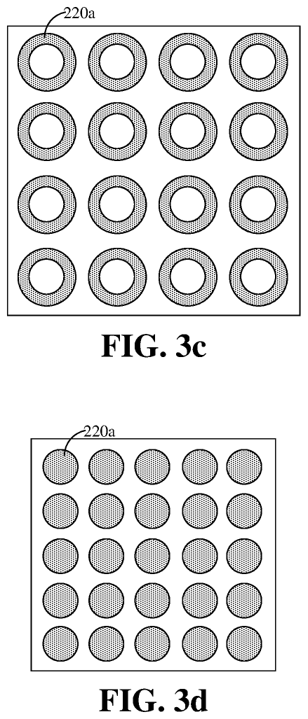

In one embodiment, geometry of the array member 220a includes a grid shape (as shown in FIG. 3a), a rectangle (as shown in FIG. 3b), a toroidal shape (as shown in FIG. 3C), a circle (as shown in FIG. 3D), an ellipse, an inverted “H” shape, a “cross” shape, and other shapes. In a same array structure 220, shapes of all the array members 220a may be same or different. For example, geometry of a projection of the periodically arranged array members 220a in the plane parallel to the rear cover 113 is rotationally symmetric or axisymmetric.

In one embodiment, each array member 220a in the at least one array structure 220 has same geometry and an area of each array member 220a is equal. For example, the array members 220a in the at least one array structure 220 are arranged in a two-dimensional array and geometry of the array member 220a may be the grid shape.

In one embodiment, each array member 220a in the at least one array structure 220 has same geometry and an area of the array member 220a arranged at a center of the at least one array structure 220 is the largest, and areas of the array members 220a emitted from the center to surrounding are gradually reduced. For example, the array members 220a in the at least one array structure 220 are arranged in a two-dimensional rectangular array of M*M, and geometry of each array member 220a in the at least one array structure 220 is a circle, and center distances or edge distances between any two adjacent array members 220a are equal. M can be 4, 5, 6 or a number greater than 6. In the embodiment of the present disclosure, the geometry of the array member 220a and a value of M are not further limited.

In the embodiment, by setting the at least one array structure 220 into the two-dimensional rectangular array of M*M, and each array in the rectangular array is in a two-dimensional gradient. Thus, the impedance bandwidth and gain frequency band of the antenna module 210 can be improved at the same time, an available frequency band can be increased, and main lobe beam width of the antenna can be narrowed, and directivity is strong.

In one embodiment, each array member 220a in the at least one array structure 220 has the same geometry and areas of each row of array members 220a in the at least one array structure 220 gradually decrease in a same direction. For example, the array members 220a in the at least one array structure 220 are arranged in the two-dimensional rectangular array of M*M, and the geometry of each array member 220a in the at least one array structure 220 is rectangular. In one embodiment, in the two-dimensional rectangular array of M*M, areas of array members 220a from a first line to a M line gradually decrease or increase in a row direction, and two adjacent array members 220a in the row direction have same trend of gradually decreasing or increasing, that is, the array members 220a in the row direction gradually decrease or increase in a same proportion. In one embodiment, in the two-dimensional rectangular array of M*M, areas of array members 220a from a first column to a M column gradually decrease or increase in a column direction, and two adjacent array members 220a in the column direction have same trend of gradually decreasing, that is, the array members 220a in the column direction gradually decrease or increase in a same proportion.

Besides, in the two-dimensional rectangular array of M*M, center distances or edge distances between any two adjacent array members 220a are equal. M can be 4, 5, 6 or a number greater than 6. In the embodiment of the present disclosure, the geometry of the array member 220a and the value of M are not further limited.

It should be noted that a center distance can be understood as a distance between centers of the two adjacent array members 220a and an edge distance can be understood as a shortest distance between edges of the two adjacent array members 220a.

In the embodiment, by setting the at least one array structure 220 into the two-dimensional rectangular array of M*M, and each array member 220a in the rectangular array is in a two-dimensional gradient. Thus, the impedance bandwidth and the gain frequency band of the antenna module 210 can be improved at the same time, the available frequency band can be increased, and the main lobe beam width of the antenna can be narrowed, and the directivity is strong.

Furthermore, when the geometry of the array member 220a is rectangular, inverted “H” shape or “cross” shape, a maximum size of the array member 220a is a maximum side length of the array member 220a. The maximum side length is less than ¼ of wavelength of the millimeter wave signals. When the geometry of the array member 220a is toroidal, circular or oval, the maximum size of the array member 220a is a maximum diameter of the array member 220a. The maximum diameter is less than ¼ of the wavelength of the millimeter wave signals.

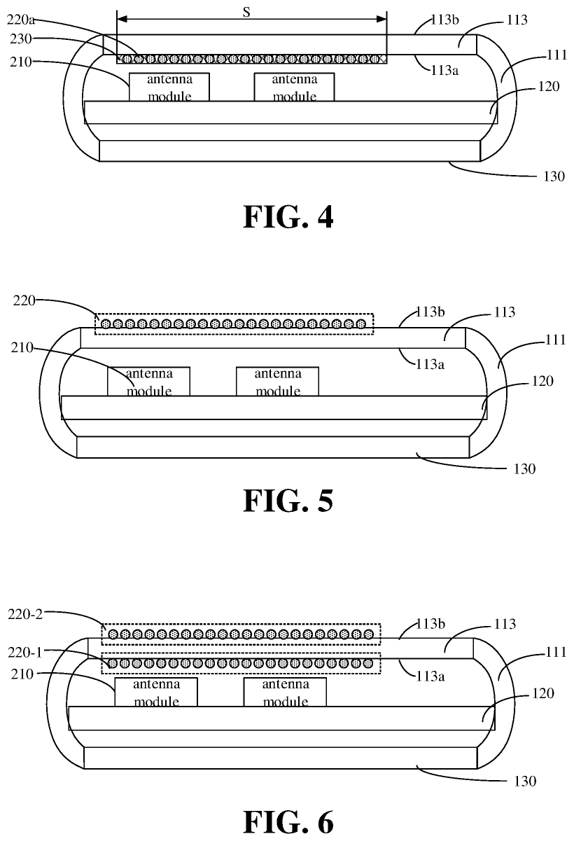

As shown in FIG. 4, in one embodiment, the antenna device further includes a dielectric layer 230 configured to be arranged on the rear cover 113, and the at least one array structure 220 is embedded in the dielectric layer 230. The dielectric layer 230 may be understood as a protective layer and may protect the at least one array structure 220, for example, from being oxidized or scratched. Materials of the dielectric layer 230 can be a polyphylene terephlate (PET) or an ARM composite material. The ARM composite material is generally synthesized from silica gel, pet and other specially treated materials.

In one embodiment, materials of the array member 220a may be conductive materials, such as metal materials, alloy materials, conductive silica gel materials, graphite materials and so on. The materials of the array member 220a may also be materials with high dielectric constant, such as glass, plastic, ceramics with high dielectric constant and so on.

In one embodiment, the at least one array structure 220 can be configured to be arranged on the first area S of the rear cover 113 by selecting an appropriate process according to a material of the at least one array structure. Specifically, for example, when the material of the at least one array structure 220 is a conductive material, the at least one array structure 220 may be printed on the rear cover 113, or the at least one array structure 220 may be electroplated on the rear cover 113. For example, when the material of the at least one array structure 220 is same with a manufacturing material of the rear cover 113, for example the ceramic with high dielectric constant, the at least one array structure 220 can also be integrated on the rear cover 113 through a processing technology of the rear cover 113.

It should be noted that in the embodiment of the present disclosure, the materials of the at least one array structure 220 and process methods configured to be arranged on the rear cover 113 are not specifically limited, and are not limited to the above examples.

In one embodiment, the rear cover 113 has a first surface 113a and a second surface 113b arranged opposite to each other. The first surface 113a may be an inner surface disposed towards the antenna module 210, and the second surface 113b may be understood as an exposed surface. Specifically, the at least one array structure 220 may be configured to be arranged on the first surface 113a, the second surface 113b and in the first area S of the rear cover or arranged inside the rear cover 113 between the first surface 113a and the second surface 113b.

As shown in FIG. 2, in one embodiment, when the at least one array structure 220 is configured to be arranged on the first surface 113a and in the first area S of the rear cover 113, a distance between the at least one array structure 220 and the radiation array of the antenna module 210 is between 0.4 mm˜1 mm.

As shown in FIG. 5, in one embodiment, when the at least one array structure 220 can be configured to be arranged on the second surface 113b and in the first area S of the rear cover 113, the distance between the at least one array structure 220 and the radiation array of the antenna module 210 is between 0.6 mm˜2 mm.

In one embodiment, when the at least one array structure 220 can be configured to be arranged inside the rear cover 113, and between the first surface 113a and the second surface 113b of the first area S of the rear cover 113, the distance between the at least one array structure 220 and the radiation array of the antenna module 210 is between 0.5 mm˜1.5 mm.

In the above embodiment, the at least one array structure 220 is configured to be arranged on the first surface 113a and in the first area S of the rear cover 113, or arranged on the second surface 113b and in the first area S of the rear cover 113 or arranged inside the rear cover 113 and between the first surface 113a and the second surface 113b. Thus, the at least one array structure 220 is closer to the radiation array, can be in near-field area of the radiation array and can be coupled with the near-field area of the radiation array, thus effectively modulating the millimeter wave signals, improving the directional pattern distortion of the millimeter wave antenna module, improving the radiation efficiency, increasing a radiation diameter, improving the gain of the antenna module, and also improving the impedance bandwidth of the antenna, being suitable for the millimeter wave wide band coverage, and improving isolation between antenna ports. In terms of space size, a radiation array size in millimeter wave module can be reduced by setting the at least one array structure 220, thus reducing a size of the antenna array module to reduce an area of the millimeter wave module in the main board.

As shown in FIG. 6, in one embodiment, the number of the at least one array structure is multiple. The at least one array structure includes the first array structure 220-1 and the second array structure 220-2. The first array structure 220-1 is configured to be arranged on the first surface 113a and in the first area S of the rear cover 113, and the second array structure 220-2 is configured to be arranged on the second surface 113b and in the first area S of the rear cover 113.

Specifically, array members 220a arranged in the first array structure 220-1 correspond to array members 220a arranged in the second array structure 220-2 one by one. For example, an array member 220a arranged in the first array structure 220-1 has same geometry as an array member 220a arranged in the second array structure 220-2, for example, both are circular and have the same period.

In the present embodiment, by setting the first array structure 220-1 on the first surface 113a of the first area S of the rear cover 113 and setting the second array structure 220-2 on the second surface 113b of the first area S of the rear cover 113, thus improving the directional pattern distortion of the millimeter wave antenna module, improving the radiation efficiency, increasing a radiation diameter, improving the gain of the antenna module, and also improving the impedance bandwidth of the antenna, being suitable for the millimeter wave wide band coverage, and improving isolation between antenna ports.

An electronic apparatus is further provided by some embodiments of the present disclosure, and includes the rear cover 113, the middle board 120 and the antenna device in any of the embodiments. The antenna module 210 is arranged between the middle board 120 and the rear cover 113, and the radiation array is arranged towards the rear cover 113.

An electronic apparatus with the antenna device in any of the above embodiments can be configured to receive and transmit 5G communication millimeter wave signals, improve the directional pattern distortion and impedance bandwidth of the antenna module 210, improve the radiation efficiency and radiation gain of the millimeter wave signals, and reduce space occupied by the antenna module 210 in the electronic apparatus.

The electronic apparatus can be a mobile phone, a tablet computer, a laptop, a handheld computer, a mobile internet device (MID), a wearable device (such as a smart watch, a smart bracelet, a pedometer, etc.) or other communication modules capable of being equipped with an antenna.

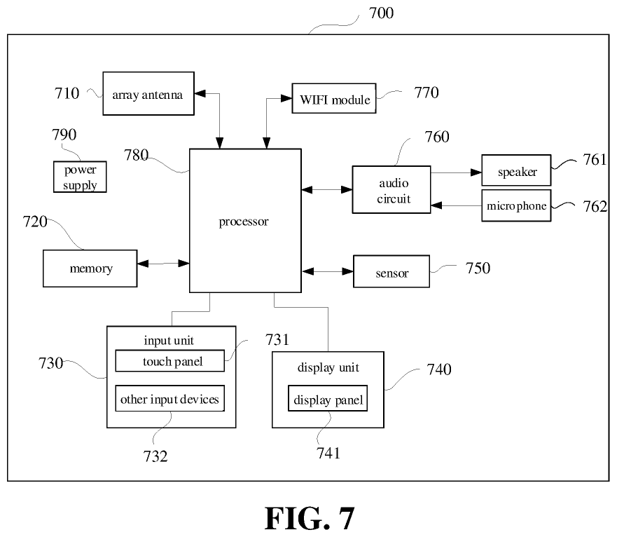

FIG. 7 is a block diagram of partial structure of a mobile phone related to an electronic apparatus provided by some embodiments of the present disclosure. As shown in FIG. 7, the mobile phone 700 includes an array antenna 710, a memory 720, an input member 730, a display member 740, a sensor 750, an audio circuit 760, a wireless fidelity (WiFi) module 770, a processor 780, a power supply 790 and other components. It can be understood by those skilled in the art that a mobile phone structure shown in FIG. 7 does not limit the structure of the mobile phone, and may include more or less components than the structure shown in FIG. 7, or combines some components, or has different component arrangements.

The array antenna 710 can be configured to receive and transmit information or receive and transmit signals during a call process, transmit downlink information received from a base station to the processor 780 after receiving downlink information, and also transmit uplink data to the base station. The memory 720 can be configured to store software programs and modules. The processor 780 performs various functional applications and data processing of the mobile phone by executing software programs and modules stored in the memory 720. The memory 720 may mainly include a program storage region and a data storage region. The program storage region can store an operating system, application programs required by at least one function (such as an application program of sound playback function, an application program of image playback function, etc.) and so on. The data storage region can store data (such as audio data, address book, etc.) created according to use of the mobile phone. In addition, the memory 720 may include a high-speed random access memory, and may also include a non-volatile memory, such as at least one of a disk storage device, a flash memory device, and other volatile solid-state storage devices.

The input member 730 may be configured to receive input digital or character information, and generate key signals input related to user settings and function control of the mobile phone 700. In one embodiment, the input member 730 may include a touch panel 731 and other input devices 732. The touch panel 731, also known as a touch screen, can collect user touch operations (such as operations on or near the touch panel 731 with a finger, stylus and any other suitable object or accessory by the user) on or near the touch panel 731 and drive a corresponding connection device according to preset programs. In one embodiment, the touch panel 731 may include a touch measuring device and a touch controller. The touch measuring device measures user's touch orientation, measures signals created by a touch operation, and transmits signals to the touch controller. The touch controller receives touch information from the touch measuring device, converts the touch information into contact coordinates, and then transmits the contact coordinates to the processor 780, and can receive and execute instructions from the processor 780. In addition, the touch panel 731 can be realized by using various types such as a resistance type, a capacitance type, an infrared ray type, a surface sound wave type or the like. The input member 730 may also include other input devices 732 besides the touch panel 731. In one embodiment, other input devices 732 may include, but not limited to, one or more of a physical keyboard, a function key (such as a volume control key, a switch key, etc.).

The display member 740 may be configured to display information entered by the user or information provided to the user and various menus of the mobile phone. The display member 740 may include a display panel 741. In one embodiment, the display panel 741 can be configured in a form of a liquid crystal display (LCD), an organic light emitting diode (OLED) or the like. In one embodiment, the touch panel 731 may cover the display panel 741. After the touch panel 731 measures a touch operation on or near the touch panel 731, the touch operation is transmitted to the processor 780 to determine a type of a touch event, and then the processor 780 provides corresponding visual output on the display panel 741 according to the type of the touch event. Although in FIG. 7, the touch panel 731 and the display panel 741 are two independent components to realize input and output functions of the mobile phone, in some embodiments, the input and output functions of the mobile phone can be realized by integrating the touch panel 731 and the display panel 741.

The mobile phone 700 may also include at least one sensor 750, such as a light sensor, a motion sensor, or other sensors. In one embodiment, the light sensor may include an ambient light sensor and a proximity sensor. The ambient light sensor can adjust brightness of the display panel 741 according to light and shade of ambient light, and the proximity sensor may turn off the display panel 741 and/or backlight the display panel 741 in response to the mobile phone being moved to an ear. The motion sensor can include an acceleration sensor. The acceleration sensor can measure acceleration in all directions, and a value and a direction of gravity in a static state, and can be used to identify mobile phone posture (such as horizontal and vertical screen switching) and vibration related functions (such as pedometer, knocking), etc. In addition, the mobile phone can also be equipped with a gyroscope, a barometer, a hygrometer, a thermometer, an infrared sensor or other sensors.

The audio circuit 760, a speaker 761 and a microphone 762 provide an audio interface between the user and the mobile phone. The audio circuit 760 can transfer an electrical signal converted from received audio data to the speaker 761, and then the speaker 761 converts the electrical signal to a sound signal to be output. On the other hand, the microphone 762 converts a collected sound signal into an electrical signal. The electrical signal is received by the audio circuit 760 and converted to audio data, and then the audio data is output to and processed by the processor 780, and can be transmitted to another mobile phone through the array antenna 710, or the audio data is output to the memory 720 for subsequent processing.

The processor 780 is a control center of the mobile phone and connects various components of the mobile phone with various interfaces and wires, performs various functions and processing data of the mobile phone by running or executing software programs and/or modules stored in the memory 720, and calling data stored in the memory 720 to monitor the whole mobile phone. In one embodiment, the processor 780 may include one or more processing members. In one embodiment, the processor 780 may integrate an application processor and a modulation and demodulation processor. The application processor mainly processes the operating system, user interface and the application program, etc. The modulation and demodulation processor mainly deals with wireless communication. It can be understood that the above-mentioned modulation and demodulation processor may also not be integrated into the processor 780.

The mobile phone 700 also includes a power supply 790 (such as a battery) that supplies power to each component. In some embodiments, the power supply 790 can be logically connected to the processor 780 through a power management system, thereby realizing functions of managing charging, discharging, and power consumption management through the power management system.

In one embodiment, the mobile phone 700 may also include a camera, a Bluetooth module, and the like.

Any reference to a memory, a storage, a database or other media used in the present disclosure may include a non-volatile memory and/or a volatile memory. A suitable non-volatile memory may include a read-only memory (ROM), a programmable ROM (PROM), an electric programmable ROM (EPROM), an electrically erasable programmable ROM (EEPROM), or a flash memory. The volatile memory may include a random access memory (RAM). The RAM is used as an external cache memory. By way of illustration and not limitation, the RAM is available in many forms, such as a static RAM (SRAM), a dynamic RAM (DRAM), a synchronous DRAM (SDRAM), a dual data rate SDRAM (DDR SDRAM), an enhanced SDRAM (ESDRAM), a synchronous link DRAM (SLDRAM), a rambus direct RAM (RDRAM), a direct rambus dynamic RAM (DRDRAM), and a rambus dynamic RAM (RDRAM).

The technical features of the above embodiments can be combined arbitrarily. In order to make the description concise, all possible combinations of each technical feature in the above embodiments are not described. However, as long as there is no contradiction between the combination of these technical features, it should be considered as the scope of the description.

The technical features in the above embodiments can be arbitrarily combined. In order to make the description concise, all possible combinations of the technical features in the above embodiments are not described. However, as long as there is no contradiction in a combination of these technical features, it should be considered as the scope of the description.

The above-mentioned examples only express several embodiments of the present disclosure, and their descriptions are more specific and detailed, but they should not be construed as limiting the scope of disclosure patents. It should be pointed out that, for those of ordinary skill in the art, several modifications and improvements may be made without departing from the concept of the present disclosure, which are all within the scope of protection of the present disclosure. Therefore, the scope of protection of the present disclosure patent shall be subject to the appended claims.

What is claimed is:

1. An electronic apparatus, comprising:
a rear cover;
an antenna module spaced from the rear cover, wherein the antenna module comprises a radiation array configured to radiate millimeter wave signals, and a beam of the millimeter wave signals points out of the rear cover; and
at least one array structure arranged on a first area of the rear cover, wherein each of the at least one array structure comprises periodically arranged array members, the first area at least comprises an area projected by the antenna module on the rear cover, and the millimeter wave signals are coupled with the at least one array structure and radiated out of the rear cover through the at least one array structure.

2. The electronic apparatus as claimed in claim 1, wherein geometry of a projection of the periodically arranged array members in a plane parallel to the rear cover is rotationally symmetric or axisymmetric.

3. The electronic apparatus as claimed in claim 2, wherein each array member in the at least one array structure has same geometry, and an area of an array member arranged at a center of the at least one array structure is largest, and areas of the array members emitted from a center to surrounding are gradually reduced.

4. The electronic apparatus as claimed in claim 3, wherein center distances or edge distances between any two adjacent array members are equal.

5. The electronic apparatus as claimed in claim 2, wherein each array member in the at least one array structure has same geometry, and areas of each row of the array members in the at least one array structure gradually decrease or increase in a same direction.

6. The electronic apparatus as claimed in claim 2, wherein,
each array member in the at least one array structure has same geometry, and an area of each array member is equal.

7. The electronic apparatus as claimed in claim 1, wherein a distance between the array members and the radiation array of the antenna module is between 0.4 mm˜2 mm.

8. The electronic apparatus as claimed in claim 1, wherein geometry of each array member is one of a rectangle, an inverted “H” shape, a toroidal shape, a circle and an ellipse.

9. The electronic apparatus as claimed in claim 1, comprising a dielectric layer arranged on the rear cover, wherein the at least one array structure is embedded in the dielectric layer.

10. The electronic apparatus as claimed in claim 1, wherein the rear cover has a first surface and a second surface arranged opposite to each other; the at least one array structure is arranged on the first surface and in the first area of the rear cover.

11. The electronic apparatus as claimed in claim 10, wherein a distance between the at least one array structure and the radiation array of the antenna module is between 0.4 mm˜1 mm.

12. The electronic apparatus as claimed in claim 1, wherein the rear cover has a first surface and a second surface arranged opposite to each other; and the at least one array structure is arranged on the second surface and in the first area of the rear cover.

13. The electronic apparatus as claimed in claim 12, wherein a distance between the at least one array structure and the radiation array of the antenna module is between 0.6 mm˜2 mm.

14. The electronic apparatus as claimed in claim 1, wherein the rear cover has a first surface and a second surface arranged opposite to each other, and the at least one array structure is arranged inside the rear cover, and between the first surface and the second surface.

15. The electronic apparatus as claimed in claim 14, wherein a distance between the at least one array structure and the radiation array of the antenna module is between 0.5 mm˜1.5 mm.

16. The electronic apparatus as claimed in claim 1, wherein the rear cover has a first surface and a second surface arranged opposite to each other; and the at least one array structure comprises a first array structure and a second array structure, the first array structure is arranged on the first surface and in the first area, and the second array structure is arranged on the second surface and in the first area.

17. The electronic apparatus as claimed in claim 1, wherein a resonant cavity is defined by coupling the antenna module and the array structure, and the resonant cavity is configured to converge a transmitted millimeter wave.

18. An antenna device for an electronic apparatus, comprising:
a rear cover,
a middle board arranged spaced from and facing the rear cover;
a plurality of antenna modules arranged on the middle board, spaced from the rear cover, and each of the plurality of antenna modules comprising a radiation array configured to radiate millimeter wave signals, and a beam of the millimeter wave signals being radiated towards the rear cover; and
an array structure arranged on the rear cover;
wherein an area of a vertical projection of the plurality of antenna modules on the rear cover is smaller than that of a vertical projection of the array structure on the rear cover, and a resonant cavity is defined by coupling the plurality of antenna modules and the array structure, and the millimeter wave signals are radiated out of the rear cover through the array structure.

19. The antenna device as claimed in claim 18, wherein the array structure is arranged on a first area of the rear cover and comprises periodically arranged array members, geometry of a projection of the periodically arranged array members in a plane parallel to the rear cover is rotationally symmetric or axisymmetric.

20. An electronic apparatus comprising:
a rear cover;
a display assembly, connected to the rear cover and define an accommodation space with the rear cover;
a middle board, arranged in the accommodation space and spaced from the rear cover;
an antenna module arranged on the middle board, located between the middle board and the rear cover and spaced from the rear cover, wherein the antenna module comprises a radiation array arranged towards the rear cover, and configured to radiate millimeter wave signals, and a beam of the millimeter wave signals points out of the rear cover; and
at least one array structure arranged on a first area of the rear cover, wherein each of the at least one array structure comprises periodically arranged array members, the first area at least comprises an area projected by the antenna module on the rear cover, the at least one array structure is excited by the millimeter wave signals, and the millimeter wave signals are coupled with signals radiated by the at least one array structure, and are radiated out of the rear cover.
